(19) United States
(12) Patent Application Publication
(10) Pub. No.: US 2021/0307576 A1
(43) Pub. Date: Oct. 7, 2021

(54) Vac-canister

(71) Applicant: Joseph Brinson, III, Greensboro, NC (US)

(72) Inventor: Joseph Brinson, III, Greensboro, NC (US)

(21) Appl. No.: 16/840,379

(22) Filed: Apr. 4, 2020

(51) Int. Cl. A47L 7/00; A47L 7/02; B65F 1/12; B65F 1/14

(52) U.S. Cl. CPC A47L 7/0047; A47L 7/02; B65F 2210/188; B65F 1/1452; B65F 1/125

(57) ABSTRACT

Cleaning device that combines the vacuum, dustpan and trashcan all in one. This device saves time by allowing the completion of multiple tasks simultaneously. This device can suction both large and small items. Small items are suctioned through the wand extension feature into the dust and trash filter bin. Some larger items can be suctioned through the dustpan and carried to the dust and trash filter bin. Other larger items that are not suctioned can be delivered to the trashcan automatically. The functionality of this device not only saves time, but also minimizes potential aches and pains as a result of daily manual cleaning activities.

### FIELD OF INVENTION

The related field of invention is the vacuum cleaner, and in particular to the suction, disposal with additional functions.

The invention is specifically geared towards a combination of unique cleaning functionality, which includes multiple ways to remove unwanted trash from the floor. For example, the suction of the vacuum is usually limited to the floor of the vacuum or the hose of the vacuum and one way of disposal of those contents. The invention is not limited to the two forms of suction nor is it limited to one way of disposal.

### BACKGROUND OF THE INVENTION

It is common that a vacuum cleaner has dual functionality for suctioning items. The dual functioning is used to improve cleaning performances but is also limited by the size of the items that can benefit from the cleaning performance of the device.

Although the typical vacuum cleaner can be used to pick up unwanted trash. Normally large items cannot be suctioned without causing damage to the device.

### SUMMARY OF THE INVENTION

It is an aspect of the present invention to provide a more diversified method to cleaning, particularly by allowing the disposal of larger items with minimum manual labor.

Multipurpose cleaning device that makes cleaning easier for individuals by combining the vacuum, dustpan and trashcan all in one device. This device can suction large items through the dustpan without damaging the suction. Items can also be discarded automatically via the attached dustpan without use of the suction.

The device saves time by allowing multiple tasks to be completed at one time. Provides convenience for daily task by providing quick and compact ways to clean.

The present invention also addresses concerns of individuals with lower back pain and/or injuries. And it also provides assistance to individuals with limited mobility by performing multiple task at once and by reducing the number of manual functions usually needed to complete task.

### BRIEF DESCRIPTION OF DRAWINGS

Components of the inventions will now be described by way of drawings and detailed examples.

FIG. 1. Is a perspective view of the Multipurpose cleaning device

FIG. 2. Is perspective view of the Lid storage compartment: This compartment is used to store accessories for the vacuum component.

FIG. 3. Is a perspective view of the hands-free lid foot operation: controlled by stepping on the foot operation on either side either of the trash can.

FIG. 4. Is a perspective view of the dustpan: The pan button controls the up and down motion of the dustpan. And it also prompts the lid of the device to open once the dustpan reaches the top of the device when discarding contents collected by the dustpan.

FIG. 5. Is a perspective view of the dual-sided dustpan handle: Allows the dustpan to be manually emptied when device needs to be charged.

FIG. 6. Is a perspective view of the dustpan, as it pertains to one of the unique features of this device When the dustpan is stationary at the bottom of the device it has a full vacuum suction functionality that is activated when the “vac button” is pressed.

FIG. 7. Is a perspective view of the handheld vacuum wand: Is used to gather dust and trash from small spaces, cracks and crevices.

FIG. 8. Is a perspective view of the vacuum components dust and trash filter: which collects the dust and trash that is suctioned through the vacuum hose.

FIG. 9. Is a perspective view of the broom compartment and the adjustable broom: A adjustable broom, adjust to multiple sizes and will be included with the vac-canister for the option of manual use.

FIG. 10. Is a perspective view of the charging tower station: provides full charge for optimal use of multipurpose cleaning device.

### DETAILED DESCRIPTION OF DRAWINGS

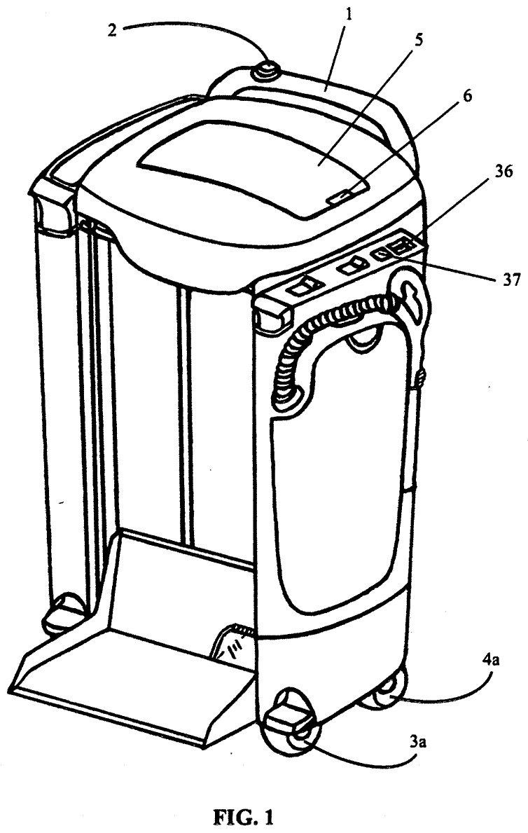

FIG. 1. Multipurpose Cleaning Device Trashcan/Handle and Wheels

1. The handle (1) is on backside device near the top:

a) Handle (1) with button (2) extends by pulling upward when button (2) is pressed.

2. Wheels are located on bottom of device; (3a, 3b, 4a, 4b)

a) Front swivel wheels (3a) and (3b) allow for easy mobility of the device, and the rear stationary wheels (4a) and (4b) provides control and stability as the device is moved to a variety of different areas for cleaning, without hassle.

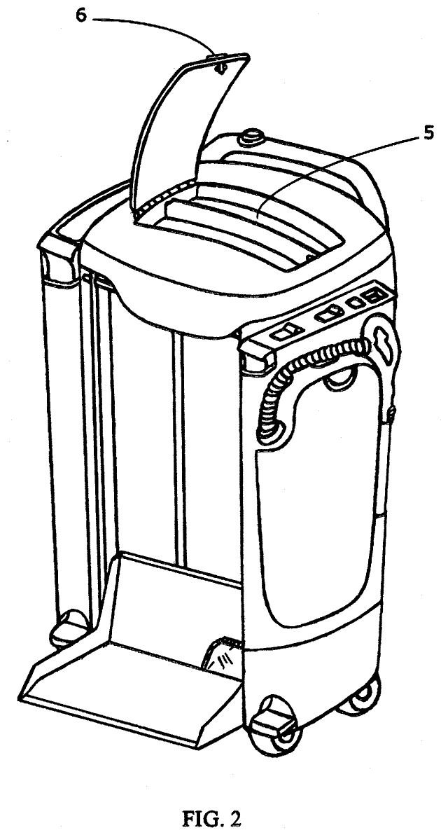

FIG. 2. Top Lid-Storage Compartment

1. Extra accessories/attachments can be stored in top lid-storage compartment (5) of vac-canister. Additional accessories/attachments can be accessed by pressing the top lid compartment latch button (6) on top of the lid.

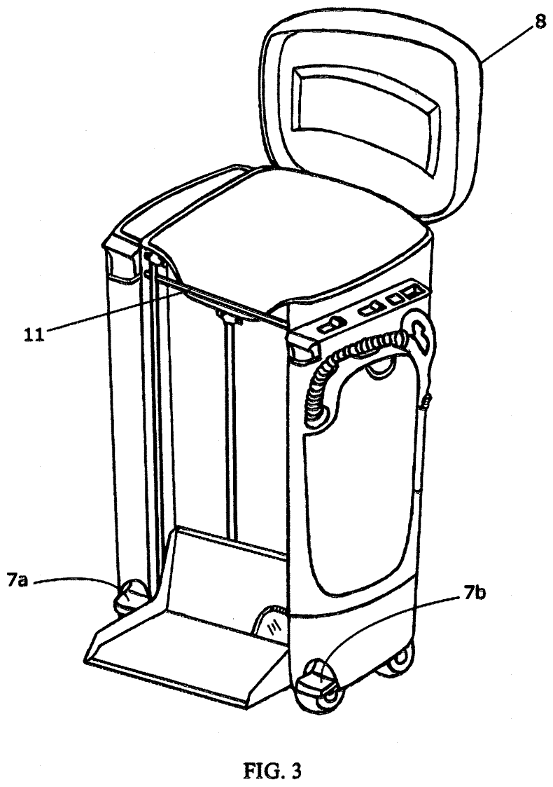

FIG. 3. Double-Sided Hands-Free Manual Front Foot Operation

1. The double-sided hands-free front manual foot operation (7a) and (7b), allows user to operate the opening and closing of the hands-free lid (8).

a) The lid (8) can be control by manually stepping on left (7a) or right-side (7b) foot operation.

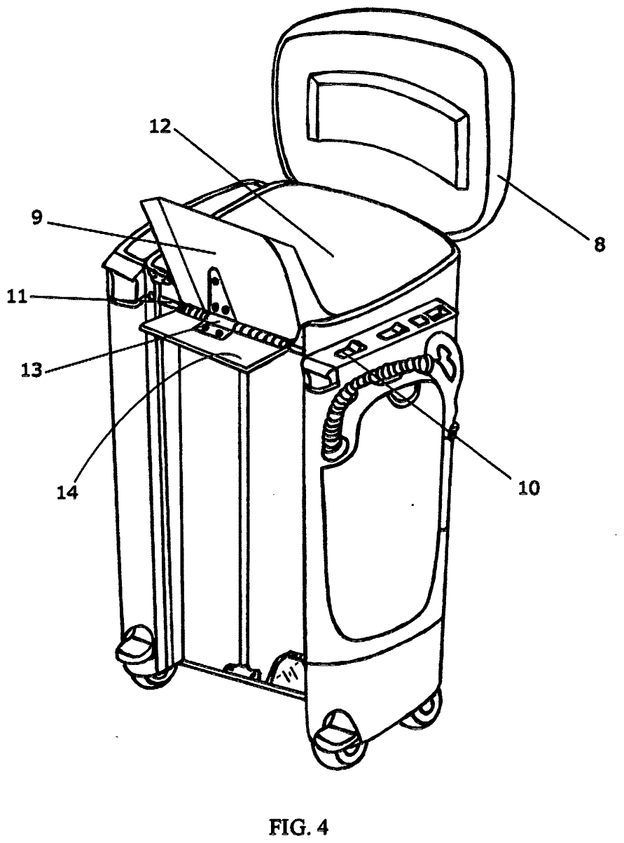

FIG. 4. Double-Sided Dustpan and Pan Button

1. Attached to the vac-canister is a dustpan (9), which is one of the unique features of this device. The device has a special pan button (10) as well.

a) The “pan” button (10) is located on top right-hand side of vac-canister. It controls the up and down motion of the dustpan (9); also, it prompts the lid (8) of the vac-canister to open once the dustpan (9) reaches the top of the device. When the dustpan (9) is located at the bottom of the device, pressing the pan button (10) will cause the dustpan (9) to move up the canister. Once it reaches a certain level the lid (8) of the device will automatically open and the flipping pole (11) near the top of the vac-canister, will flip the double-sided dustpan (9) inward towards the trashcan (12) causing content to be transferred from the first side of the dustpan (9) onto the second side to discard the contents. The dustpan (9) is prevented from falling into the trashcan (12) because of the hinge (13) connected to the dustpan platform (14). Once contents are discarded, the dustpan (9) then returns to the bottom of the device in the stationary position.

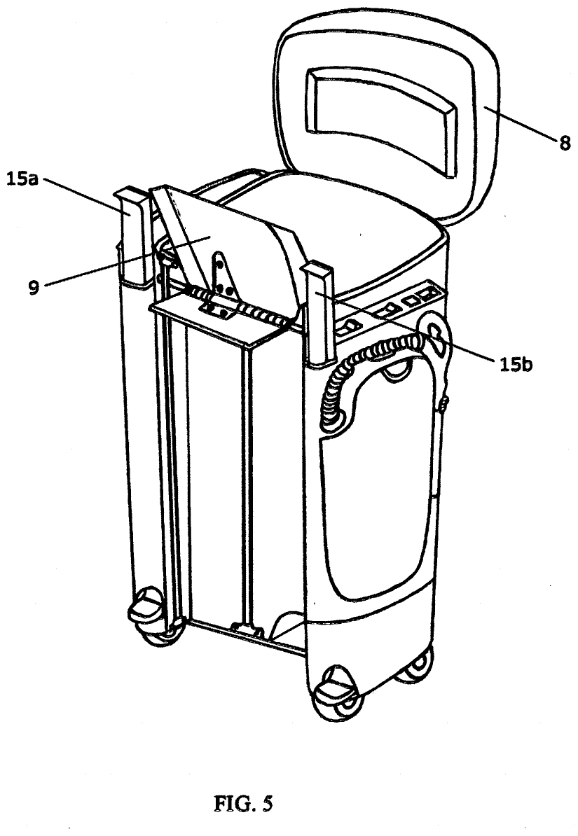

FIG. 5. Manual Duel Sided Dustpan Handle 1. Double-Sided Dustpan Handle (15a) and (15b);

a) Allows the dustpan (9) to be manually emptied when device needs to be charged

b) By lifting manual dustpan handle on left side (15a), or manual dustpan handle on the right side(15b), the user will be able dispose of trash and lid (8) will open as dustpan (9) nears top of the device,

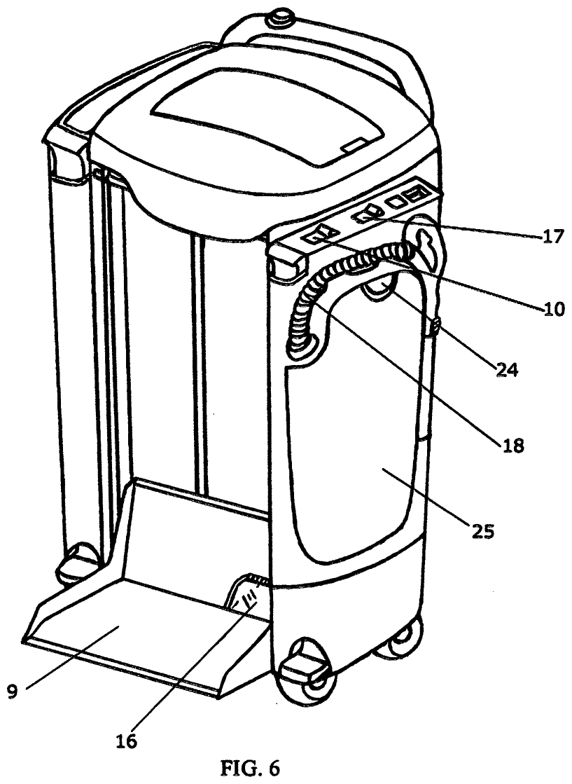

FIG. 6. Dustpan with Suction Flap/“Vac” Button:

The dustpan (9) has a suction flap (16), which is another unique feature of this device. When the dustpan (9) is in the stationary position at the bottom of the device, it has a full vacuum suction functionality. This vacuum feature is activated when the “vac button” (17) is pressed. The flap (16) of the dustpan (9) that is aligned with the vacuum hose (18) opens allowing contents that are manually swept in the dustpan (9) to be suctioned. For items that are too large to be suctioned through the vacuum hose (18), the dustpan (9) will be dispose of the remaining content by pressing the “pan button” (10).

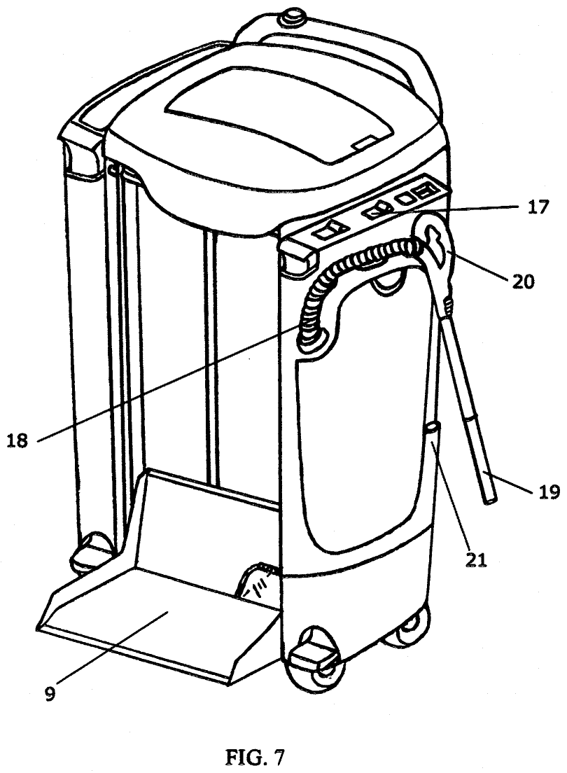

FIG. 7. Handheld Vacuum Wand with Hose

1. Handheld vacuum wand (19): Is used to gather dust and trash from small spaces, cracks and crevices.

a) For use of the handheld vacuum wand (19), grab the handle of the vacuum wand (20) and lift vacuum wand (19) from its designated slot (21). The removal of the vacuum wand (19) automatically transfers the suction from the dustpan (9) to the wand (19) when the “vac” button (17) is pressed on.

b) Pressing the “Vac” button (17) will control suction through the hose (18) and trash and dust will be disposed into the dust and trash filter bin (22).

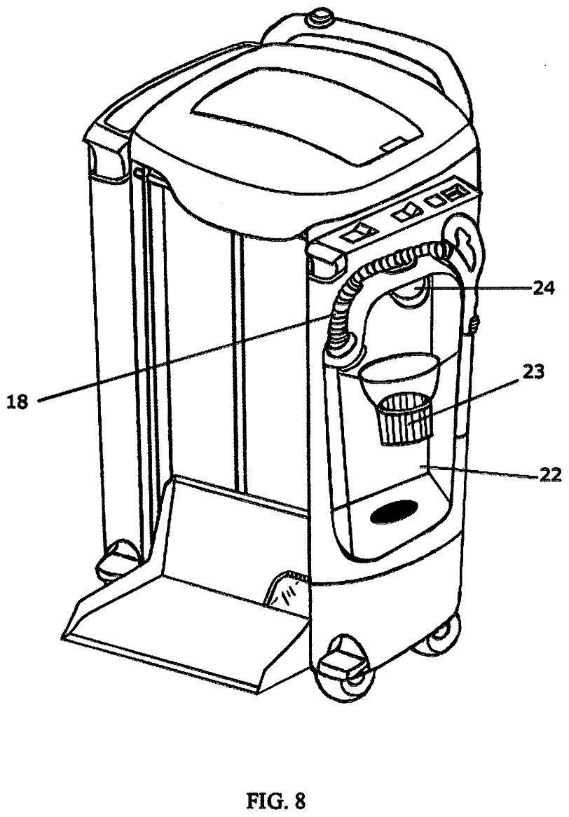

FIG. 8. Dust/Trash Filter Bin

The vacuum contains a dust filter (23) inside of the trash filter bin (22), which collects the dust, and trash that is suctioned through the vacuum hose (18).

a) The dust and trash filter bin (22) can be emptied by pulling up on the vacuum door latch (24) which provides access to the filtered bin (22) so that dust and trash collected can manually be disposed of. Once emptied, place bin (22) with dust filter (23) back into the compartment. Once the vacuum door (25) is closed, it will latch (24) in place keeping the dust and trash filter bin (22) secure.

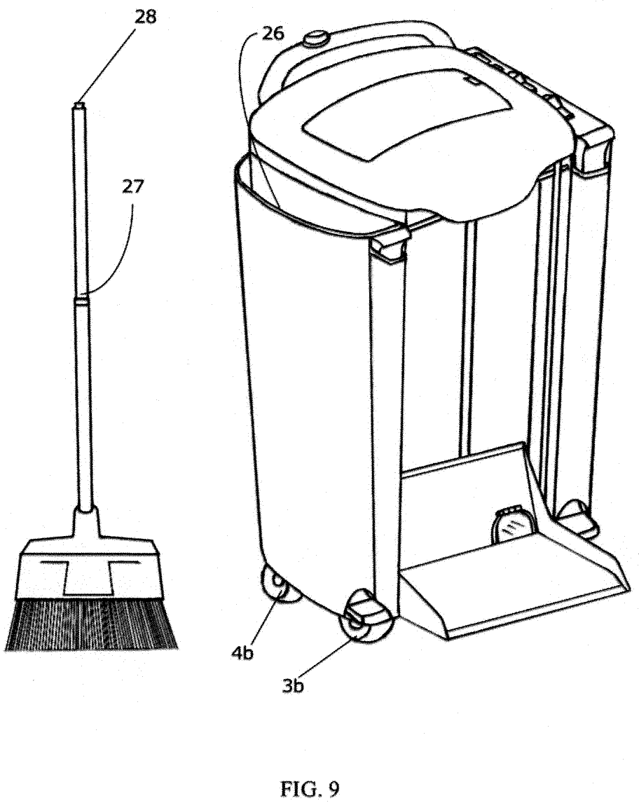

FIG. 9. Adjustable Broom & Broom Storage Compartment

1. Broom compartment (26) houses an adjustable broom (27) will be included with the device for the option of manual use.

a) Left side broom compartment (26) is where larger cleaning tools such as an adjustable broom (27) or similar cleaning tools can be stored.

2. The adjustable broom (27) can be adjusted to multiple sizes.

a) The adjustable broom (27) comes with an adjustment button (28) on the top of the broom (27). When the button (28) is pressed it will allow the broom (27) to adjust to a variety of different sizes.

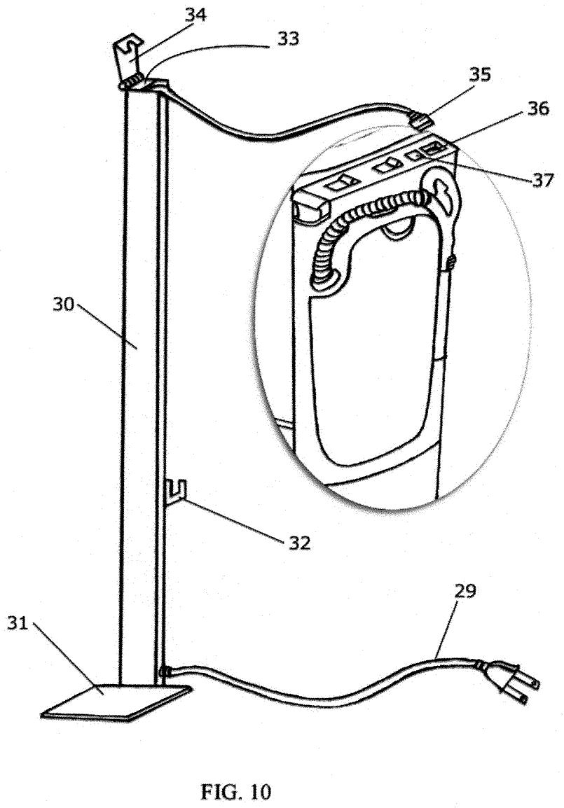

FIG. 10. Charging Station Charging Tower Station (30):

a) Power cord (29) is attached to the charging tower station (30) which is located near the bottom base (31) of the charging tower station (30). For optimal use, plug power cord (29) from the charging tower station (30) into a wall outlet. In the case that the full length of the power cord (29) is not being used, the charging tower station (30) has a U-hook (32) that the excess power cord (29) can be stored on.

b) The charging cord storage compartment (33) located at the top of the charging tower has a lid cover (34) that opens up and gives access the charging cord with magnetic charging end (35). Pull the charging cord (29) with magnetic charging end (35) from the top of the charging tower, and plug magnetic charging end (35) into top charging slot (36) on the multi-cleaning device. The charging slot (36) is located on the right-hand side of the vac-canister, directly behind the “pan” (10) and vac buttons (17). The Charging light (37) will illuminate once the vac-canister begins charging.

c) Once fully charged, unplug magnetic charging end (35) and place back into designated spot on charging tower (29). Now ready for full use.

1. A vacuum built into a trashcan, with an attached dustpan that moves up and down the trashcan and discards small and large items comprising:
a vacuum suction function when the dustpan is in the stationary position at the bottom of the device, dustpan contains flap that aligns with the vacuum hose, and trashcan having left side compartment and top lid compartment; the up and down motion of the dustpan controls the motion censored lid functionality; the left side compartment extending from the central portion of the device; the top lid compartment extending into the central portion of the device; 2. The vacuum suction of claim 1 is built inside of the trashcan and a second section of the suction extends outside of the trashcan for manual usage.

3. A vacuum cleaner having an attached trashcan and dustpan according to claim 1.

4. Adjustable broom comprising:
A top broom handle adjustment release button, handle that adjust to multiple sizes;

5. A method of storing cleaning tools and accessories, left side compartment and top lid compartment, the method comprising:
a. Providing trashcan units large left side compartment, and smaller top lid compartment;
b. inserting at least one large cleaning tool into the left side compartment opening provided, and inserting smaller accessories into top lid compartment provided;

6. Dual-sided manual dustpan handles are part of dustpan function comprising;
an up and down function of the dustpan manually; able to discard small and large items as said in claim 1.
